(19) United States
(12) Patent Application Publication
(10) Pub. No.: US 2026/0175861 A1
(43) Pub. Date: Jun. 25, 2026

(54) DRIVING ASSISTANCE DEVICE, DRIVING ASSISTANCE METHOD, NON-TRANSITORY COMPUTER-READABLE STORAGE MEDIUM, AND VEHICLE SYSTEM

(71) Applicant: HONDA MOTOR CO., LTD., Tokyo (JP)

(72) Inventors: Kenjiro TORII, Saitama (JP); Kiri YOSHIDA, Saitama (JP); Kohei MATSUDA, Saitama (JP); Shigenobu SAIGUSA, Tokyo (JP)

(21) Appl. No.: 19/408,577

(22) Filed: Dec. 4, 2025

(30) Foreign Application Priority Data
Dec. 24, 2024 (JP) 2024-227756

(51) Int. Cl. B60W 50/14; B60W 30/18; B60W 40/08; B60W 50/00; G06V 20/56; G06V 20/59; G06V 40/18

(52) U.S. Cl. CPC B60W 50/14; B60W 30/18163; B60W 40/08; B60W 50/0097; G06V 20/56; G06V 20/597; G06V 40/18; B60W 2050/143; B60W 2420/403; B60W 2540/225

(57) ABSTRACT

A driving assistance device for a vehicle, the driving assistance device includes: a surrounding environment recognition unit that recognizes surrounding environment of the vehicle; a lane change prediction unit that predicts whether there is a possibility that the vehicle will change lanes; and a gaze recognition unit that recognizes a gaze of a driver; and a notification unit that performs notification by sound by controlling a speaker when it is predicted that there is a possibility that the vehicle will change lanes and there is a nearby vehicle on a lane into which the vehicle is going to change lanes, wherein the notification unit changes a notification mode based on a direction of the gaze.

### TECHNICAL FIELD

The present invention relates to a driving assistance device, a driving assistance method, a control program (stored in a non-transitory computer-readable storage medium), and a vehicle system.

### BACKGROUND ART

In recent years, there has been an increase in efforts to provide sustainable transportation systems that take into account people in vulnerable situations among traffic participants. To realize this, research and development related to driving assistance technology and autonomous driving technology are conducted to further improve the safety and convenience of traffic.

JP2009-20570A discloses a driving assistance device for assisting lane change. When the vehicle changes lanes, the driving assistance device performs notification by displaying nearby vehicles present around the vehicle on the display unit in the meter panel and outputting a voice message. Thereby, the driver can recognize the nearby vehicles.

When changing lanes, the driver needs to visually check the lane to which the lane change is to be made and the nearby vehicles traveling on the lane. In the case where the driver recognizes the nearby vehicles by visually checking, excessive notification by the driving assistance device may be annoying to the driver.

### SUMMARY OF THE INVENTION

In view of the foregoing background, an object of the present invention is to provide a driving assistance device, a driving assistance method, a control program, and a vehicle system that can provide notification according to the driver's behavior when changing lanes.

To achieve the above object, one aspect of the present invention provides a driving assistance device for a vehicle, the driving assistance device comprising: a surrounding environment recognition unit that recognizes surrounding environment of the vehicle; a lane change prediction unit that predicts whether there is a possibility that the vehicle will change lanes; and a gaze recognition unit that recognizes a gaze of a driver; and a notification unit that performs notification by sound by controlling a speaker when it is predicted that there is a possibility that the vehicle will change lanes and there is a nearby vehicle on a lane into which the vehicle is going to change lanes, wherein the notification unit changes a notification mode based on a direction of the gaze.

Another aspect of the present invention provides a driving assistance method for a vehicle, wherein the driving assistance method is to be executed by a computer and comprises: recognizing surrounding environment of the vehicle; predicting whether there is a possibility that the vehicle will change lanes; recognizing a gaze of a driver; performing notification by sound by controlling a speaker when it is predicted that there is a possibility that the vehicle will change lanes and there is a nearby vehicle on a lane into which the vehicle is going to change lanes; and changing a notification mode based on a direction of the gaze.

Another aspect of the present invention provides a non-transitory computer-readable storage medium, comprising a stored control program, the control program configured to cause a computer to execute a driving assistance method for a vehicle, the driving assistance method comprising: recognizing surrounding environment of the vehicle; predicting whether there is a possibility that the vehicle will change lanes; recognizing a gaze of a driver; performing notification by sound by controlling a speaker when it is predicted that there is a possibility that the vehicle will change lanes and there is a nearby vehicle on a lane into which the vehicle is going to change lanes; and changing a notification mode based on a direction of the gaze.

Another aspect of the present invention provides a vehicle system, comprising: an external environment recognition device that detects an object outside a vehicle; a driver camera that captures an image of a driver; and a driving assistance device that provides driving assistance for the driver, wherein the driving assistance device comprises: a surrounding environment recognition unit that recognizes surrounding environment of the vehicle based on a signal from the external environment recognition device; a lane change prediction unit that predicts whether there is a possibility that the vehicle will change lanes; a gaze recognition unit that recognizes a gaze of the driver based on the image of the driver captured by the driver camera; and a notification unit that performs notification by sound by controlling a speaker when it is predicted that there is a possibility that the vehicle will change lanes and there is a nearby vehicle on a lane into which the vehicle is going to change lanes, wherein the notification unit changes a notification mode based on a direction of the gaze.

According to the above aspects of the present invention, a driving assistance device, a driving assistance method, a control program, and a vehicle system that can provide notification according to the driver's behavior when changing lanes can be provided.

### BRIEF DESCRIPTION OF THE DRAWINGS

FIG. 1 is a configuration diagram of a driving assistance device according to an embodiment;

FIG. 2 is an explanatory diagram of a merging area; and

FIG. 3 is a flowchart of driving assistance control executed by the driving assistance device.

### DETAILED DESCRIPTION OF THE INVENTION

In the following, embodiments of a driving assistance device, a driving assistance method, a control program, and a vehicle system will be described with reference to the drawings.

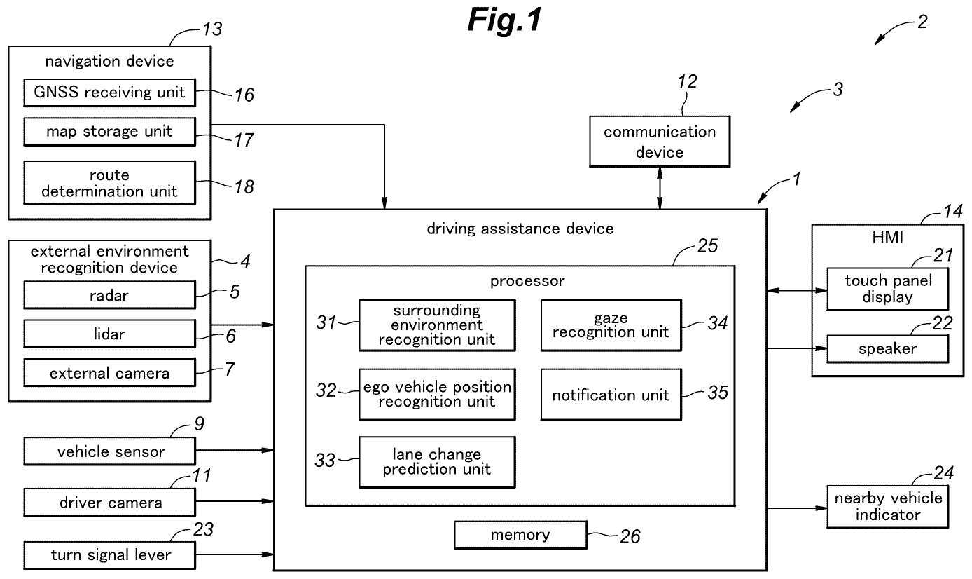

As shown in FIG. 1, a driving assistance device 1 is provided in a vehicle 2. The vehicle 2 may be a four-wheeled automobile, for example. The driving assistance device 1 constitutes a part of a vehicle system 3 provided in the vehicle 2.

The vehicle system 3 includes an external environment recognition device 4. The external environment recognition device 4 is a device that detects objects outside the vehicle 2. The external environment recognition device 4 is a sensor that detects objects or the like outside the vehicle 2 by capturing electromagnetic waves or light from the surroundings of the vehicle 2. The external environment recognition device 4 includes a radar 5, a lidar 6, and an external camera 7, for example.

The vehicle system 3 includes a vehicle sensor 9. The vehicle sensor 9 includes a vehicle speed sensor that detects the speed of the vehicle 2 and an acceleration sensor that detects the acceleration of the vehicle 2. The vehicle sensor 9 may include a yaw rate sensor that detects an angular velocity around a vertical axis, a direction sensor that detects the direction of the vehicle 2, etc.

The vehicle system 3 includes a driver camera 11 for capturing an image of the driver. The driver camera 11 may be a digital camera using a solid imaging element such as a CCD or a CMOS, for example. The driver camera 11 acquires a driver image which is an image of the driver. The driver image may be a still image repeatedly acquired at a predetermined time interval or a video.

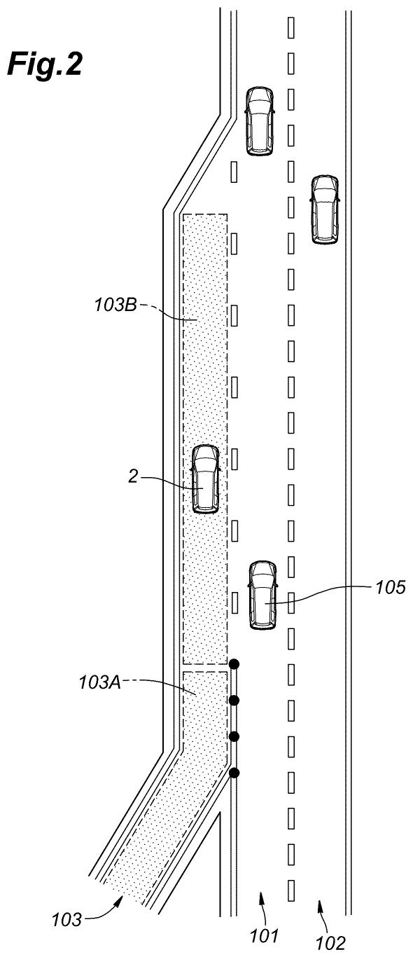

The vehicle system 3 includes a communication device 12, a navigation device 13, and a human machine interface (HMI) 14. The communication device 12 mediates the communication of the driving assistance device 1 and the navigation device 13 with nearby vehicles 105 (see FIG. 2) and a server located outside the vehicle 2.

The navigation device 13 is a device that acquires the current position of the vehicle 2 and provides route guidance to the destination and other functions. The navigation device 13 preferably includes a global navigation satellite system (GNSS) receiving unit 16, a map storage unit 17, and a route determination unit 18. The GNSS receiving unit 16 identifies the position (latitude and longitude) of the vehicle 2 based on signals received from artificial satellites (positioning satellites). The map storage unit 17 is composed of a known storage device such as a flash memory or a hard disk and stores map information.

The HMI 14 notifies the occupant of various kinds of information by display and/or voice and receives input operations performed by the occupant. The HMI 14 preferably includes a touch panel display 21 including a liquid crystal display, an organic EL display, or the like and a speaker 22. The touch panel display 21 may function as a navigation interface through which input to/output from the navigation device 13 is performed.

The vehicle system 3 includes a turn signal lever 23. The turn signal lever 23 is an operation input device with which the driver operates direction indicators. According to the driver's operation, the turn signal lever 23 outputs a signal corresponding to the movement to the right or left to the driving assistance device 1.

The vehicle system 3 includes a nearby vehicle indicator 24 for indicating the presence of nearby vehicles 105. The nearby vehicle indicator 24 turns on when there is a nearby vehicle 105 within a predetermined range around the vehicle 2 to make the driver aware of the presence of the nearby vehicle 105. The nearby vehicle indicator 24 is a so-called Blind Spot Information (BSI) system. The nearby vehicle indicator 24 is preferably provided on each side mirror of the vehicle 2, for example.

The driving assistance device 1 is a computer including a processor 25 and a memory 26 communicatively connected to the processor 25. The processor 25 preferably includes, as a core, at least one of a central processing unit (CPU), a graphics processing unit (GPU), and a reduced instruction set computer (RISC), for example. The memory 26 stores a control program executed by the processor 25 and various data. The memory 26 preferably includes at least one of a volatile memory and a non-volatile memory. The volatile memory may be a dynamic random access memory (DRAM) or a static random access memory (SRAM), for example. The non-volatile memory may be a solid state drive (SSD), a flash memory, a magnetic disk storage device, or an optical disk storage device. At least a part of the driving assistance device 1 may be realized by hardware such as a large scale integration (LSI) circuit, an application specific integrated circuit (ASIC), or a field-programmable gate array (FPGA) or may be realized by a combination of software and hardware. The driving assistance device 1 may be composed of one piece of hardware or may be composed of multiple pieces of hardware capable of communicating with each other. A part of the driving assistance device 1 may be configured by an external server provided outside the vehicle 2.

The processor 25 implements various applications by executing the control program stored in the memory 26. The control program may be stored in a removable recordable medium such as a DVD or a CD-ROM and may be installed into the memory 26 when the recordable medium is read by a reading device. Also, the control program may be downloaded via a communication network such as the internet and installed into the memory 26.

By executing the control program stored in the memory 26, the processor 25 functions as a surrounding environment recognition unit 31, an ego vehicle position recognition unit 32, a lane change prediction unit 33, a gaze recognition unit 34, and a notification unit 35.

The surrounding environment recognition unit 31 recognizes the surrounding environment of the vehicle 2. The surrounding environment recognition unit 31 recognizes, based on the detection result of the external environment recognition device 4, the surrounding environment (external environment) including obstacles present around the vehicle 2, road shape, lane markings, presence or absence of sidewalks, road markings, etc. The obstacles include guardrails, utility poles, nearby vehicles 105 (see FIG. 2), and persons such as pedestrians, for example. The surrounding environment recognition unit 31 can acquire a state, such as the position, velocity, and acceleration of each nearby vehicle 105 from the detection result of the external environment recognition device 4.

The ego vehicle position recognition unit 32 recognizes the position of the vehicle 2 (ego vehicle). The ego vehicle position recognition unit 32 preferably recognizes the position of the vehicle 2 based on the GNSS signal received by the GNSS receiving unit 16. Also, the ego vehicle position recognition unit 32 preferably recognizes the area in which the vehicle 2 is present based on the position of the vehicle 2 and the map information. For example, as shown in FIG. 2, the area preferably includes main lanes 101, 102 and a merging lane 103 that merges with the main lane 101. The merging lane 103 preferably includes a preparation section 103A and a mergeable section 103B. The mergeable section 103B extends in parallel with the main lane 101. The vehicle 2 can change lanes into the main lane 101 in the mergeable section 103B. The preparation section 103A is separated from the main lane 101 by a hard nose, such as walls, or a soft nose, such as traffic poles.

The lane change prediction unit 33 predicts whether there is a possibility that the vehicle 2 will change lanes. The lane change prediction unit 33 may predict whether there is a possibility that the vehicle 2 will change lanes based on the area in which the vehicle 2 is present. For example, the lane change prediction unit 33 may predict that there is a possibility that the vehicle 2 will change lanes when the vehicle 2 is in the mergeable section 103B. Also, the lane change prediction unit 33 may predict that there is a possibility that the vehicle 2 will change lanes based on the signal from the turn signal lever 23. Namely, the lane change prediction unit 33 may determine whether the turn signal lever 23 is operated based on the signal corresponding to rightward or leftward movement which is outputted from the turn signal lever 23 and may predict that there is a possibility that the vehicle 2 will change lanes when the turn signal lever 23 is operated. Also, the lane change prediction unit 33 may predict that there is a possibility that the vehicle 2 will change lanes when the vehicle 2 is in the mergeable section 103B and the turn signal lever 23 is operated.

The gaze recognition unit 34 recognizes a gaze of the driver. The gaze recognition unit 34 recognizes the gaze of the driver based on the driver image. The gaze is preferably represented by a start point of the gaze and a gaze vector representing the direction of the gaze. The start point of the gaze is preferably a part between the eyes of the driver, for example.

The gaze recognition unit 34 preferably acquires the gaze of the driver from the driver image by using a trained model generated by machine learning, for example. The trained model has been trained to output a gaze of the driver for each driver image inputted. The trained model may be preferably generated by performing machine learning by inputting training data that includes multiple driver images and gazes of the driver corresponding to the multiple driver images to a neural network.

The notification unit 35 performs notification by sound by controlling the speaker 22 when it is predicted that there is a possibility that the vehicle 2 will change lanes and there is a nearby vehicle 105 on the lane into which the vehicle 2 is going to change lanes. The notification unit 35 acquires information on whether there is a possibility that the vehicle 2 will change lanes from the lane change prediction unit 33.

The lane on which the vehicle 2 is traveling is referred to as the current lane, and the lane into which the vehicle 2 is going to change lanes is referred to as the target lane. The notification unit 35 preferably determines the target lane based on the surrounding environment of the vehicle 2 acquired by the surrounding environment recognition unit 31. For example, when it is determined that there is no lane to the left of the current lane based on the surrounding environment of the vehicle 2, the notification unit 35 preferably sets the lane to the right of the current lane as the target lane. When it is determined that there is no lane to the right of the current lane based on the surrounding environment of the vehicle 2, the notification unit 35 preferably sets the lane to the left of the current lane as the target lane. Also, when the vehicle 2 is in the mergeable section 103B, the notification unit 35 preferably sets the main lane 101 as the target lane.

The notification unit 35 may determine the target lane based on the signal from the turn signal lever 23. For example, when a signal corresponding to rightward movement is received from the turn signal lever 23, the notification unit 35 preferably sets the lane to the right of the current lane as the target lane. Also, when a signal corresponding to leftward movement is received from the turn signal lever 23, the notification unit 35 preferably sets the lane to the left of the current lane as the target lane.

The notification unit 35 determines whether there is a nearby vehicle 105 on the target lane based on the surrounding environment of the vehicle 2 acquired by the surrounding environment recognition unit 31. The nearby vehicles 105 that are eligible are preferably those positioned within a predetermined range from the vehicle 2. Also, the nearby vehicles 105 that are eligible may be those whose time to collision (TTC) with the vehicle 2 is less than or equal to a predetermined value.

The notification by sound performed by the notification unit 35 is preferably outputted from the speaker 22. The notification by sound includes at least one of a verbal speech and a warning sound. The speech may be “there is a nearby vehicle,” “check nearby vehicles,” etc., for example. The warning sound may be a beep or a buzzing sound generated by a buzzer, for example. The notification mode preferably includes a low-level notification mode in which notification is performed by speech and a high-level notification mode in which notification is performed by speech and warning sound. The higher the level of the notification mode, the stronger the degree of warning may become. The content of the speech may be changed to provide a stronger warning as the level of the notification mode increases. Also, as the level of the notification mode increases, the volume of the warning sound may be increased and/or the warning sound may be changed to provide a stronger sense of urgency.

The notification unit 35 changes the notification mode based on a direction of the gaze of the driver. Preferably, the notification unit 35 determines whether the gaze turned in a direction of lane change during a predetermined determination period, and changes the notification mode based on the determination result. For example, the determination period is preferably set to the past one to three seconds with respect to when the determination is completed. The direction of lane change is set toward the target lane from the current lane. The direction of lane change is preferably represented as rightward or leftward.

The notification unit 35 preferably determines whether the gaze turned in the direction of lane change based on the angle of the gaze of the driver in the left-right direction. For example, in the case where the direction of lane change is rightward, the notification unit 35 preferably determines that the gaze turned in the direction of lane change when the angle of the gaze of the driver in the rightward direction became greater than or equal to a predetermined angle, such as 45 degrees.

Also, the notification unit 35 may determine whether the gaze turned in the direction of lane change based on whether the gaze of the driver passed through a preset right region or left region. The right region and the left region are preferably regions corresponding to the right side surface and the left side surface of the vehicle 2. Specifically, the right region is preferably set as a region to the right of the right front pillar of the vehicle 2, and the left region is preferably set as a region to the left of the left front pillar of the vehicle 2. For example, in the case where the direction of lane change is rightward, the notification unit 35 preferably determines that the gaze turned in the direction of lane change when the gaze of the driver passed through the right region set to the right of the right front pillar of the vehicle 2.

The notification unit 35 preferably raises the level of the notification mode in the case where the gaze of the driver did not turn in the direction of lane change during the determination period than in the case where the gaze of the driver turned in the direction of lane change during the determination period. Thereby, in a situation where a lane change is expected, the driver who is not checking in the direction of lane change can be more strongly prompted to check the target lane.

The notification unit 35 may change the notification mode depending on the elapsed time from when the gaze turned in the direction of lane change. Specifically, it is preferable that the longer the elapsed time from when the gaze turned in the direction of lane change, the higher the notification unit 35 raises the level of the notification mode. Preferably, the notification unit 35 starts measurement of time from when the gaze of the driver turns in the direction of lane change, and resets the measured time when the gaze turns again in the direction of lane change. Thereby, the notification unit 35 can prompt the driver to visually check the latest situation of the nearby vehicles 105 on the target lane. For example, the notification unit 35 may stop the notification when the elapsed time is less than or equal to a first threshold. When the elapsed time is greater than the first threshold and is less than or equal to a second threshold that is set to a value greater than the first threshold, the notification unit 35 may perform notification by speech. When the elapsed time is greater than the second threshold, the notification unit 35 may increase the volume of the speech or change the content of the speech to provide a stronger sense of urgency than when the elapsed time is less than or equal to the second threshold. Also, when the elapsed time is greater than the second threshold, the notification unit 35 may generate a warning sound in addition to speech.

The notification unit 35 may change the notification mode based on the operation state of the turn signal lever 23. The notification unit 35 preferably raises the level of the notification mode when the turn signal lever 23 is not operated. Also, the notification unit 35 may perform notification by speech such as “operate the turn signal lever” or “prepare for lane change” when the turn signal lever 23 is not operated.

The notification unit 35 turns on the nearby vehicle indicator 24 when there is a nearby vehicle 105 within a predetermined range around the vehicle 2. The notification unit 35 may change the lighting mode of the nearby vehicle indicator 24 based on the operation state of the turn signal lever 23. The notification unit 35 may cause the nearby vehicle indicator 24 to blink, namely, to turn on and off intermittently when there is a nearby vehicle 105 within the predetermined range around the vehicle 2 and the turn signal lever 23 is operated. Also, the notification unit 35 may continuously turn on the nearby vehicle indicator 24 when there is a nearby vehicle 105 within the predetermined range around the vehicle 2 and the turn signal lever 23 is not operated.

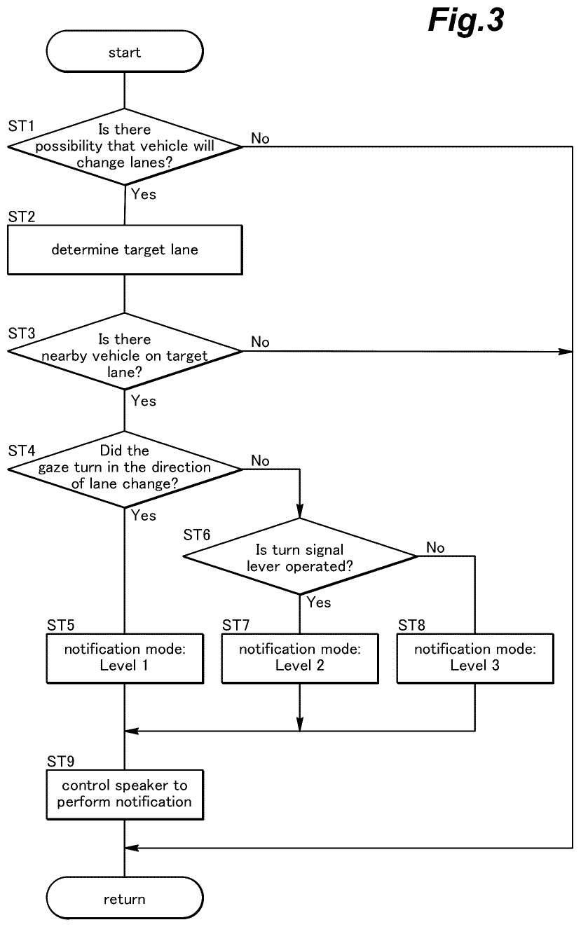

The driving assistance device 1 preferably performs driving assistance control according to the control procedure of the driving assistance control shown in FIG. 3. The driving assistance device 1 first predicts whether there is a possibility that the vehicle 2 will change lanes (ST1). The determination in ST1 is preferably performed by the lane change prediction unit 33 as described above. When there is no possibility that the vehicle 2 will change lanes (ST1: No), the process proceeds to “return” and the driving assistance control is repeated from ST1.

When there is a possibility that the vehicle 2 will change lanes (ST1: Yes), the driving assistance device 1 determines the lane into which the lane change is to be made, namely, the target lane (ST2). Subsequently, the driving assistance device 1 determines whether there is a nearby vehicle 105 on the target lane within the predetermined range from the vehicle 2 (ST3). When there is no nearby vehicle 105 on the target lane within the predetermined range from the vehicle 2 (ST3: No), the process proceeds to “return” and the driving assistance control is repeated from ST1.

When there is a nearby vehicle 105 on the target lane within the predetermined range from the vehicle 2 (ST3: Yes), the driving assistance device 1 determines whether the gaze turned in the direction of lane change within the determination period (ST4). In the case where the gaze turned in the direction of lane change within the determination period (ST4: Yes), the driving assistance device 1 sets the notification mode to Level 1 (ST5). The notification mode of Level 1 is included in the low-level notification mode and is preferably a mode in which notification by speech is performed.

In the case where the gaze of the driver did not turn in the direction of lane change during the determination period (ST4: No), the driving assistance device 1 determines whether the turn signal lever 23 is operated (ST6). In the case where the turn signal lever 23 is operated (ST6: Yes), the driving assistance device 1 sets the notification mode to Level 2. In the case where the turn signal lever 23 is not operated (ST6: No), the driving assistance device 1 sets the notification mode to Level 3. The notification mode of Level 2 and the notification mode of Level 3 are included in the high-level notification mode, and are preferably modes in which notification by speech and warning sound is performed. In the notification mode of Level 3, the degree of warning is set higher than in the notification mode of Level 2.

Following the processes in steps ST5, ST7, and ST8, the driving assistance device 1 controls the speaker 22 according to the set notification mode to thereby perform the notification (ST9).

According to the embodiment described above, in a state in which lane change is expected, the driving assistance device 1 can perform notification by sound to prompt the driver to pay attention to the nearby vehicles 105 traveling on the destination lane of the lane change. The notification mode changes depending on whether the gaze of the driver turned in the destination lane of the lane change. Namely, the notification mode changes depending on whether the driver visually checked the destination lane of the lane change. In the case where the driver visually checked the destination lane of the lane change, the driving assistance device 1 lowers the level of the notification mode to reduce the annoyance of the driver. On the other hand, in the case where the driver failed to visually check the destination lane of the lane change, the driving assistance device 1 can raise the level of the notification mode to give the driver a stronger warning. Also, when the driver is not operating the turn signal lever 23, the driving assistance device 1 can further raise the level of the notification mode to give the driver an even stronger warning.

The embodiment may be modified in various ways without being limited to the above-described configuration. For example, the gaze recognition unit 34 may detect the direction of the driver's head from the driver image and may estimate the gaze of the driver based on the direction of the head. Also, the driving assistance device 1 may change the notification mode based on the direction of the driver's head instead of the direction of the gaze. In this case, the driving assistance device 1 preferably includes a head recognition unit for detecting the direction of the driver's head instead of the gaze recognition unit 34.

Also, the notification unit 35 may estimate the driver's psychological state based on the driver images acquired by the driver camera 11 and may change the notification mode based on the estimated psychological state. For example, the driving assistance device 1 may use a trained model that outputs the driver's psychological state in response to input of the driver images, thereby to acquire the driver's psychological state from the driver images. The posture, number of blinks, gaze fluctuation, and head movement of the driver acquired from the driver images are presumed to be related to the driver's psychological state. For example, the driver's psychological state may be represented by a tension level and may be expressed as a numerical value. The higher the tension level, the more tense the driver is, and the lower the tension level, the more relaxed the driver is. The notification unit 35 may lower the level of the notification mode as the tension level becomes higher. When the driver is tense, the notification by sound from the speaker 22 can make the driver more tense and can be a burden on the driver. Therefore, when the driver is tense, by lowering the level of the notification mode, it is possible to encourage the driver to drive appropriately. For example, when the tension level is lower than or equal to a predetermined first threshold, the notification unit 35 may perform both notification by speech and notification by warning. When the tension level is higher than the first threshold and is lower than or equal to a predetermined second threshold that is higher than the first threshold, the notification unit 35 may perform only notification by speech. Further, when the tension level is higher than the second threshold, the notification unit 35 may stop the notification.

The above embodiment may be described as follows.

One embodiment is a driving assistance device 1 for a vehicle 2, the driving assistance device 1 comprising: a surrounding environment recognition unit 31 that recognizes surrounding environment of the vehicle 2; a lane change prediction unit 33 that predicts whether there is a possibility that the vehicle 2 will change lanes; a gaze recognition unit 34 that recognizes a gaze of a drive; and a notification unit 35 that performs notification by sound by controlling a speaker when it is predicted that there is a possibility that the vehicle 2 will change lanes and there is a nearby vehicle 105 on a lane into which the vehicle 2 is going to change lanes, wherein the notification unit 35 changes a notification mode based on a direction of the gaze.

According to this aspect, the driving assistance device 1 can provide notification according to the driver's behavior when changing lanes. Specifically, the driving assistance device 1 can perform notification according to the notification mode based on the direction of the gaze of the driver.

In the above embodiment, the notification unit 35 may determine whether the gaze turned in a direction of lane change during a predetermined determination period and may change the notification mode based on a determination result.

According to this aspect, the driving assistance device 1 can change the notification mode depending on whether the driver looked in the direction of lane change.

In the above embodiment, in a case where the gaze of the driver did not turn in the direction of lane change during the determination period, the notification unit 35 may raise a level of the notification mode than in a case where the gaze turned in the direction of lane change during the determination period.

According to this aspect, in the case where the driver did not look in the direction of lane change, the driving assistance device 1 can perform stronger notification than in the case where the driver looked in the direction of lane change to give the driver a stronger warning.

In the above embodiment, the notification unit 35 may change the notification mode depending on an elapsed time from when the gaze turned in the direction of lane change. Also, the longer the elapsed time from when the gaze turned in the direction of lane change, the higher the notification unit 35 may raise a level of the notification mode.

According to this aspect, the driving assistance device 1 can prompt the driver to check in the direction of lane change again. After the driver checked in the direction of lane change, the situation changes constantly, and thus, in the case where some time has passed since the driver last checked, it is safer to check again.

In the above embodiment, the notification unit 35 may change the notification mode based on an operation state of a turn signal lever 23.

According to this aspect, when the driver is not operating the turn signal lever 23, for example, it is possible to perform stronger notification thereby to prompt the driver to operate the turn signal lever 23.

In the above embodiment, the notification mode may include a low-level notification mode in which notification is performed by speech and a high-level notification mode in which notification is performed by speech and warning sound.

According to this aspect, it is possible to change the notification mode depending on the situation and to provide warnings appropriate for the state of the driver.

Another embodiment is a driving assistance method for a vehicle 2, wherein the driving assistance method is to be executed by a computer and comprises: recognizing surrounding environment of the vehicle 2; predicting whether there is a possibility that the vehicle 2 will change lanes; recognizing a gaze of a driver; performing notification by sound by controlling a speaker when it is predicted that there is a possibility that the vehicle will change lanes and there is a nearby vehicle 105 on a lane into which the vehicle 2 is going to change lanes; and changing a notification mode based on a direction of the gaze.

According to this aspect, a driving assistance method that can provide notification according to the driver's behavior when changing lanes can be provided.

Another embodiment is a non-transitory computer-readable storage medium, comprising a stored control program, the control program configured to cause a computer to execute a driving assistance method for a vehicle 2, the driving method comprising: recognizing surrounding environment of the vehicle 2; predicting whether there is a possibility that the vehicle 2 will change lanes; recognizing a gaze of a driver; performing notification by sound by controlling a speaker when it is predicted that there is a possibility that the vehicle will change lanes and there is a nearby vehicle 105 on a lane into which the vehicle 2 is going to change lanes; and changing a notification mode based on a direction of the gaze.

According to this aspect, a control program for executing a driving assistance method that can provide notification according to the driver's behavior when changing lanes can be provided.

Another embodiment is a vehicle system 3, comprising: an external environment recognition device 4 that detects an object outside a vehicle 2; a driver camera 11 that captures an image of a driver; and a driving assistance device 1 that provides driving assistance for the driver, wherein the driving assistance device 1 comprises: a surrounding environment recognition unit 31 that recognizes surrounding environment of the vehicle 2 based on a signal from the external environment recognition device 4; a lane change prediction unit 33 that predicts whether there is a possibility that the vehicle 2 will change lanes; a gaze recognition unit 34 that recognizes a gaze of the driver based on the image of the driver captured by the driver camera 11; and a notification unit 35 that performs notification by sound by controlling a speaker when it is predicted that there is a possibility that the vehicle 2 will change lanes and there is a nearby vehicle 105 on a lane into which the vehicle 2 is going to change lanes, wherein the notification unit 35 changes a notification mode based on a direction of the gaze.

According to this aspect, a vehicle system executing a driving assistance method that can provide notification according to the driver's behavior when changing lanes can be provided.

1. A driving assistance device for a vehicle, the driving assistance device comprising:
a surrounding environment recognition unit that recognizes surrounding environment of the vehicle;
a lane change prediction unit that predicts whether there is a possibility that the vehicle will change lanes; and
a gaze recognition unit that recognizes a gaze of a driver; and
a notification unit that performs notification by sound by controlling a speaker when it is predicted that there is a possibility that the vehicle will change lanes and there is a nearby vehicle on a lane into which the vehicle is going to change lanes,
wherein the notification unit changes a notification mode based on a direction of the gaze.

2. The driving assistance device according to claim 1, wherein the notification unit determines whether the gaze turned in a direction of lane change during a predetermined determination period and changes the notification mode based on a determination result.

3. The driving assistance device according to claim 2, wherein in a case where the gaze of the driver did not turn in the direction of lane change during the determination period, the notification unit raises a level of the notification mode than in a case where the gaze turned in the direction of lane change during the determination period.

4. The driving assistance device according to claim 1, wherein the notification unit changes the notification mode depending on an elapsed time from when the gaze turned in the direction of lane change.

5. The driving assistance device according to claim 4, wherein the longer the elapsed time from when the gaze turned in the direction of lane change, the higher the notification unit raises a level of the notification mode.

6. The driving assistance device according to claim 1, wherein the notification unit changes the notification mode based on an operation state of a turn signal lever.

7. The driving assistance device according to claim 3, wherein the notification mode includes a low-level notification mode in which notification is performed by speech and a high-level notification mode in which notification is performed by speech and warning sound.

8. A driving assistance method for a vehicle, wherein the driving assistance method is to be executed by a computer and comprises:
recognizing surrounding environment of the vehicle;
predicting whether there is a possibility that the vehicle will change lanes;
recognizing a gaze of a driver;
performing notification by sound by controlling a speaker when it is predicted that there is a possibility that the vehicle will change lanes and there is a nearby vehicle on a lane into which the vehicle is going to change lanes; and
changing a notification mode based on a direction of the gaze.

9. A non-transitory computer-readable storage medium, comprising a stored control program, the control program configured to cause a computer to execute the driving assistance method according to claim 8.

10. A vehicle system, comprising:
an external environment recognition device that detects an object outside a vehicle;
a driver camera that captures an image of a driver; and
a driving assistance device that provides driving assistance for the driver,
wherein the driving assistance device comprises:
a surrounding environment recognition unit that recognizes surrounding environment of the vehicle based on a signal from the external environment recognition device;
a lane change prediction unit that predicts whether there is a possibility that the vehicle will change lanes;
a gaze recognition unit that recognizes a gaze of the driver based on the image of the driver captured by the driver camera; and
a notification unit that performs notification by sound by controlling a speaker when it is predicted that there is a possibility that the vehicle will change lanes and there is a nearby vehicle on a lane into which the vehicle is going to change lanes,
wherein the notification unit changes a notification mode based on a direction of the gaze.
